(19) United States
(12) Patent Application Publication
(10) Pub. No.: US 2006/0151468 A1
(43) Pub. Date: Jul. 13, 2006

(54) Cooking apparatus

(75) Inventors: Han-seong Kang, Suwon-si (KR); Yong-hyun Kwon, Suwon-si (KR); Chul Kim, Yongin-si (KR); Han-jun Sung, Suwon-si (KR); Seong-deog Jang, Suwon-si (KR); Dae-sung Han, Hwaseong-si (KR); Tae-uk Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/257,111

(22) Filed: Oct. 25, 2005

(30) Foreign Application Priority Data
Jan. 13, 2005 (KR) 2005-3309

(51) Int. Cl. H05B 3/68

(52) U.S. Cl. 219/450.1

(57) ABSTRACT

A cooking apparatus having a grill part to cook food thereon, and electric heaters as a heating source to cook food, including: a grill reflecting member reflecting a heat generated from the electric heaters to the grill part, having an oil guiding hole which guides oil coming out of food being cooked; and an oil collector disposed in a lower side of the grill reflection member, collecting the oil passing through the oil guiding hole downward. Thus, the oil generated in the course of cooking can be collected in the oil collector through the grill reflection member, thereby providing a cooking apparatus that can enhance cooking efficiency.

### CROSS-REFERENCE TO RELATED APPLICATIONS

This application claims the benefit of Korean Patent Application No. 2005-0003309, filed on Jan. 13, 2005, in the Korean Intellectual Property Office, the disclosure of which is incorporated herein by reference.

### BACKGROUND OF THE INVENTION

1. Field of the Invention

The present invention relates to a cooking apparatus, and more particularly, to a cooking apparatus having an oil collector which can collect the oil coming out of food being cooked.

2. Description of the Related Art

Conventionally, “grilling” refers to a method of broiling meats, fishes or shellfishes, etc. on a gridiron or directly roasting skewered meats or fishes on the fire. A grill device as a kind of household appliance refers to a device to broil them by using electricity or gas, etc.

An electric grill device cooks food by using electric heaters as the heating source to generate heat using electric power. A main body of the electric grill device includes a grill part directly contacting and cooking food. The heat generated by the electric heaters is reflected to the grill part by a grill reflecting member and used when food is cooked.

A conventional grill device disclosed in Korean Patent First Publication No. 2004-39155 includes a main body having a box shape; a plurality of heating members provided inside the main body, for heating food; a grill member disposed in an upper part of the main body, for making food seated thereon; and a heat reflection member disposed in a lower part of the main body, for transmitting a radiant heat of the heating member to the grill member.

In the conventional cooking device, if means are provided to collect the oil generated from food collected on the heat reflection member, because the oil generated from food is collected thereon, the heat reflecting efficiency of the heat reflection member and the cooking efficiency corresponding thereto may further be enhanced.

### SUMMARY OF THE INVENTION

Accordingly, it is an aspect of the present invention to provide a cooking apparatus having an oil collector that can collect the oil coming out of food being cooked.

Additional aspects and/or advantages of the invention will be set forth in part in the description which follows and, in part, will be apparent from the description, or may be learned by practice of the invention.

The foregoing and/or other aspects of the present invention are achieved by providing a cooking apparatus having a grill part to cook food thereon, and electric heaters as heating source to cook food, including: a grill reflecting member reflecting heat generated from the electric heaters to the grill part, having an oil guiding hole which guides oil coming out of food being cooked; and an oil collector disposed in a lower side of the grill reflection member, collecting the oil passing through the oil guiding hole downward.

According to an aspect of the present invention, the oil guiding hole may be formed on both side areas of the grill reflecting member.

According to an aspect of the present invention, the cooking apparatus may further include a grill housing coupled with the grill part on an upper side of the grill housing, being formed in an accommodating space inside thereof and where the oil collector is received in the grill housing to be disposed in the lower part of the grill reflecting member.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is an exploded perspective view illustrating a cooking apparatus according to the present invention;

FIG. 2 is an exploded perspective view illustrating a grill part and a grill housing of the cooking apparatus according to the present invention;

FIG. 3 is a sectional view of the cooking apparatus taken along line III-III of FIG. 2 to illustrate that the assembly of the grill part and the grill housing.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

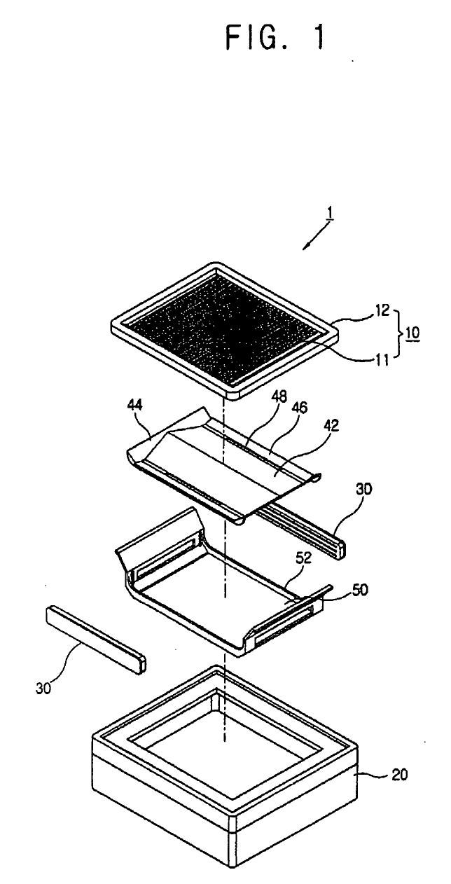

As illustrated in FIG. 1, a cooking apparatus 1 according to the present invention includes a grill part 10 on which food is cooked, a grill housing 20 coupled to a lower part of the grill part 10, receiving therein a variety of parts and accessories.

The grill part 10 directly contacting and cooking food is coupled with an upper part of the grill housing 20. The grill part 10 includes a plurality of grill bars 11 disposed at predetermined intervals so as to safely seat food thereon, and a support frame 12 supporting the plurality of grill bars 11 along the circumferential direction.

The grill housing 20 supports the lower part of the grill part 10 mounted on an upper opening part thereof, inside of which a heating space is formed. Inside of the grill housing 20 are electric heaters 30 formed in a pair as the heating source, a grill reflecting member 40 reflecting heat from the electric heaters 30, and an oil collector 50 collecting oil in a lower part of the grill reflecting member 40.

The electric heaters 30 are installed oppositely to each other on both side walls inside the grill housing 20 so that they are disposed in the lower part of the grill part 10. The heat generated in the electric heaters 30 is transmitted to the grill part 10 by the grill reflecting member 40.

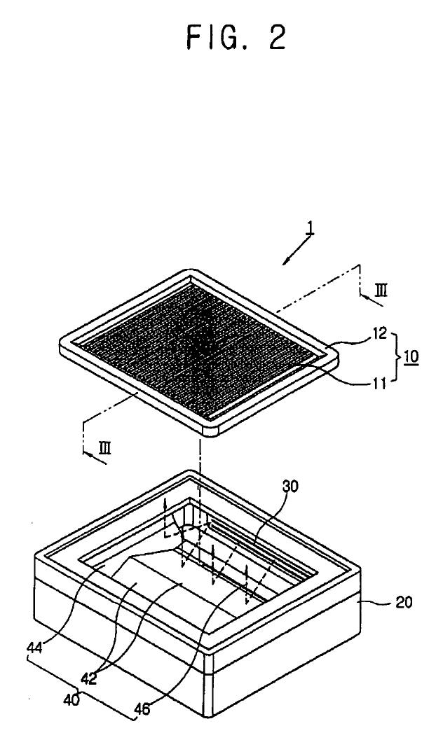

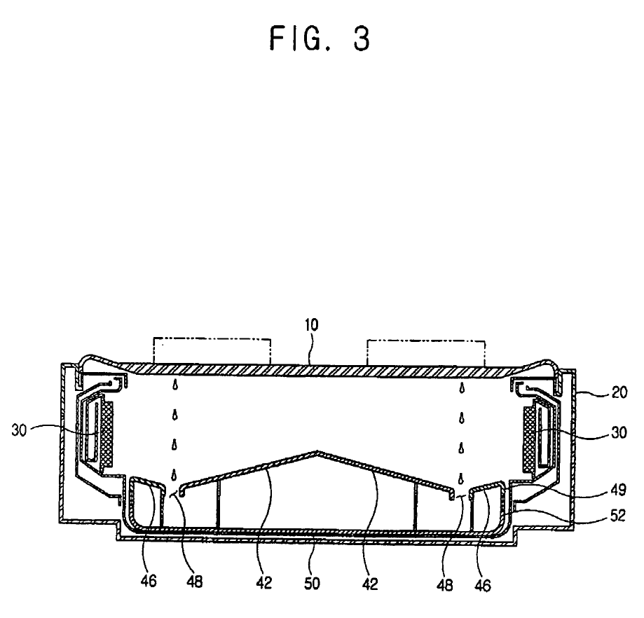

As illustrated in FIGS. 2 and 3, the grill reflecting member 40 has an approximately w-shaped section. The grill reflecting member 40 may be made of metallic materials having a good thermal conductivity so as to reflect the heat generated from the electric heaters 30 and then transmit it to the grill part 10.

The grill reflecting member 40 has a pair of first reflection faces 42 interconnected in the center, auxiliary reflection faces 46 formed oppositely to the first reflection faces 42, and a second reflection face 44 extended from the ends of the first reflection faces 42 and the auxiliary reflection faces 46.

The first reflection faces 42 are disposed in the direction of the heat emitted from the electric heaters 30, that is, in front of the electric heaters 30, to thereby reflect the heat generated from the electric heaters 30 to the grill part 10 in a bent manner.

The auxiliary reflection faces 46 are adjacent to the electric heaters 30, so that their temperatures become high while the cooking apparatus 1 is in operation. On the ends of the auxiliary reflection faces 46 are formed bent side plate parts 49 which are coupled to the oil collector 50.

An oil guiding hole 48 is formed between the auxiliary reflection faces 46 and the first reflection faces 42, which guides the oil coming out of food being cooked downward. Accordingly, the oil passing through the oil guiding hole 48 is collected in the oil collector 50 disposed in the lower part of the grill reflection member 40.

The second reflection face 44 is disposed laterally to the heat emitting direction of the electric heaters 30. The second reflection face 44 is smoothly curved so as to allow the heat generated from the electric heaters 30 to be reflected to the grill part 10 in a bent manner.

Meanwhile, as illustrated in FIG. 3, the oil collector 50 collecting the oil passing through the oil guiding hole 48 is coupled in the lower part of the grill reflection member 40 with the first reflection faces 42, the auxiliary reflection faces 46 and the second reflection face 44.

The oil collector 50 having an approximately w-shaped cross section forms an accommodating space which receives the oil or residues coming out of food being cooked. Side wall parts 52 of the oil collector 50 are coupled with the side plate parts 49 of the grill reflection member 40, so that the oil collector 50 disposed in the lower side of the grill reflection member 40 may collect oil falling down from the grill part 10 through the oil guiding hole 48.

Hereinbelow, a process of guiding the oil generated in the course of cooking to the oil collector 50 passing through the oil guiding hole 48 will be described.

As illustrated in FIG. 3, the grill reflection member 40 coupled with the oil collector 50 in the lower side thereof and the electric heaters 30 are accommodated inside the grill housing 20. The grill part 10 is disposed in the upper side of the grill housing 20. In this configuration, the heat generated from the electric heaters 30 is transmitted to the grill part 10 by being reflected in the grill reflection member 40. Therefore, food is cooked on the grill part 10, and the oil coming out from food being cooked falls down to the grill reflection member 40. At this time, the oil falling down to the grill reflection member 40 is guided to the oil collector 50 disposed in the lower part of the grill reflection member 40 through the oil guiding hole 48.

That is, the oil collector 50 collecting the oil falling down to the grill reflection member 40 is provided, so that the oil is collected in the oil collector 50 instead of the grill reflection member 40, thereby enhancing the heat reflecting efficiency of the grill reflection member 40 and cooking efficiency corresponding thereto.

Further, the oil does not collect in the grill reflection member 40, so that the fumes generated due to oil collecting in the grill reflection member 40 can be suppressed and the cleaning is also simplified after food is cooked.

As described above, according to the present invention, oil generated in the course of cooking can be collected in the oil collector through the grill reflection member, thereby providing cooking apparatus that can enhance cooking efficiency.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cooking apparatus having a grill part to cook food thereon, and electric heaters as a heating source to cook food, comprising:
a grill reflecting member reflecting a heat generated from the electric heaters to the grill part, having an oil guiding hole which guides oil coming out of food being cooked; and
an oil collector disposed on a lower side of the grill reflection member, collecting the oil passing through the oil guiding hole downward.

2. The cooking apparatus according to claim 1, wherein the oil guiding hole is formed on both side areas of the grill reflecting member.

3. The cooking apparatus according to claim 2, further comprising:
a grill housing coupled to the grill part on a upper side of the grill housing, being formed in an accommodating space inside thereof,
wherein the oil collector is received in the grill housing to be disposed in the lower part of the grill reflecting member.

4. A cooking apparatus, comprising:
a grill part on which food is cooked;
a grill housing coupled to a lower part of the grill part;
a pair of electric heaters disposed on the inside of the grill housing;
a grill reflecting member to reflect heat from the electric heaters; and
an oil collector for collecting oil in a lower part of the grill reflecting member.

5. The cooking apparatus of claim 4, wherein the electric heaters are installed oppositely to each other inside the grill housing 20 so that they are disposed in the lower part of the grill part.

6. The cooking apparatus of claim 4, wherein the grill reflecting member has a w-shaped cross section.

7. The cooking apparatus of claim 4, wherein the grill reflecting member is made of metallic materials.

8. The cooking apparatus of claim 4, wherein the grill reflecting member comprises:
a pair of first reflection faces interconnected at the center of the grill reflecting member;
a pair of auxiliary reflection faces formed opposite to the first reflection faces; and
a pair of second reflection faces extended from the ends of the first reflection faces and the auxiliary reflection faces,
wherein the first reflection faces are disposed in the direction of the heat emitted from the electric heaters.

9. The cooking apparatus of claim 8, wherein the auxiliary reflection faces are adjacent to the electric heaters.

10. The cooking apparatus of claim 8, further comprising bent side plate parts formed on the ends of the auxiliary reflection faces,
wherein the bent side plate parts are coupled to the oil collector.

11. The cooking apparatus of claim 8, further comprising at least one oil guiding hole formed between the auxiliary reflection faces and the first reflection faces,
wherein the oil guiding hole leads to the oil collector.
